(19) United States
(12) Patent Application Publication
(10) Pub. No.: US 2020/0256397 A1
(43) Pub. Date: Aug. 13, 2020

(54) DOUBLE CARDAN ANGLES CONTROLLED BY MOUNTING FRAME

(71) Applicant: AGCO Corporation, Duluth, GA (US)

(72) Inventors: Bernard Dean Regier, Hesston, KS (US); David W. O'Reilly, Hesston, KS (US)

(21) Appl. No.: 16/639,653

(22) PCT Filed: Jul. 11, 2018
(86) PCT No.: PCT/IB2018/055103

§ 371 Date: Feb. 17, 2020

Related U.S. Application Data
(60) Provisional application No. 62/545,560, filed on Aug. 15, 2017.

(51) Int. Cl. F16D 3/32; F16D 3/84

(52) U.S. Cl. CPC F16D 3/32; A01B 71/06; F16D 3/845

(57) ABSTRACT

In one embodiment, a drive axle, comprising: a first axle frame comprising a first pair of gears at opposing sides of one end of the first axle frame, each of the gears comprising a hole; a second axle frame comprising a second pair of gears at opposing sides of one end of the second axle frame adjacent the one end of the first axle frame, each of the gears comprising a hole, the first pair of gears intermeshing with the second pair of gears throughout an articulation range; a center frame disposed between the first and second axle frames, the first and second axle frames coupled to the center frame by plural pins disposed in the holes of the first and second pairs of gears; a driving shaft surrounded at least in part by the first axle frame and comprising a first yoke; a driven shaft surrounded at least in part by the second axle frame and comprising a second yoke; and a double cardan joint, the double cardan joint coupled to the first and second yokes, wherein the center frame surrounds at least a portion of the double cardan joint.

### CROSS REFERENCE TO RELATED APPLICATION

This application claims the benefit of U.S. Provisional Application No. 62/545,560 filed Aug. 15, 2017, which is hereby incorporated by reference in its entirety.

### TECHNICAL FIELD

The present disclosure is generally related to joints that enable the transmission of rotary motion between two shafts of a drive axle.

### BACKGROUND

Front or rear drive axles (or sometimes, referred to as drive shafts) comprise joints (e.g., universal (U) joints, constant velocity (CV) joints, double cardan joints, etc.) that are used to transmit torque and rotation from a driveline, the latter whose rotation is powered by an engine, to the drive axle. The joints, generally speaking, enable the connection among other components that cannot be connected directly due to distance or the need to enable relative motion between the components. In other words, the joints of a drive axle allow a variation in alignment and distance between a driving component and a driven component. In one example application, drive axle (also, steering system axle) joints enable a vehicle to be steered in different directions while conveying the rotational power of the driveline to the wheels. Referring to FIG. 1A, shown is an example drive axle 10 comprising axle frames 12A and 12B that are hinged at a single location 14 where respective ends of the axle frames 12A and 12B overlap. The hinged connection is achieved on top and bottom sides of the overlapping portion of the axle frames 12A and 12B via a single king pin on each side extending through the respective overlapped portions (e.g., kingpins, not shown). Running centrally through the axle frame 12B is a driving shaft 16 having a yoke 18 at least at one end (the opposing end operably connected to a driveline (not shown)). Running centrally through the axle frame 12A is a driven shaft 20 that likewise has a yoke 22 at least at one end (the other end operably coupled to a wheel). The driving shaft 16 and the driven shaft 20 are operably coupled to each other via the mechanisms of a center or coupling yoke 24. The center yoke 24 comprises a double cardan joint. The double cardan joint, as is known, comprises two back-to-back yokes 26, 28, each yoke 26, 28 comprising a single U-joint 30, 32, respectively. A U-joint is sometimes referred to as a cross. The U-joint 30 couples the yoke 26 of the center yoke 24 to the yoke 22 of the driven shaft 20. The U-joint 32 couples the yoke 28 of the center yoke 24 to the yoke 18 of the driving shaft 16.

One shortcoming to a single king-pin type, double cardan joint is the inability to maintain the same velocity (rotational speed) between the driving shaft 16 and the driven shaft 20 at angles other than zero degrees (e.g., the fully, or straight, aligned position). For instance, and referring to FIG. 1B, shown is a screen shot of a chart diagram 34 depicting a measurement of velocity or rotational speed (Y-axis in degrees/second (deg/sec)) versus time (X-axis, in seconds) for the driving shaft 16 and the driven shaft 20, where the angle of articulation between the driving shaft 16 and the driven shaft 20 in this example is at 35 degrees. The velocity measure for the driving shaft 16 is represented by line 36, and the velocity measure for the driven shaft 20 is represented by the line 38. As shown in this example, the velocity of the driving shaft 16 is measured at 5 deg/sec, whereas the velocity of the driven shaft 20 is a sinusoidal signal with positive peaks of approximately 5.045 deg/sec and negative peaks of approximately 4.965 deg/sec. In other words, the same velocity is not maintained between the driving shaft 16 and the driven shaft 20 for the articulated angle of 35 degrees. In fact, measurements at even greater articulation angles (e.g., 52 degrees, 90 degrees) reveal even greater swings of velocities. Indeed, the only articulation angle where the driving shaft 16 and driven shaft 20 have equal velocity measurements for the single king pin, double cardan joint is at zero degrees. Without equal velocities, the wheels may hop and shudder (e.g., excessive vibration) as well as the drivelines (e.g., shudder), particularly for steering applications when the vehicle is turned very sharply. One reason for the inequality of velocity measurements between the two shafts 16 and 20 is that the U-joints 30, 32 are at different angles when the angle of articulation is at any angle other than zero degrees.

### BRIEF DESCRIPTION OF THE DRAWINGS

Many aspects of certain embodiments of the disclosure can be better understood with reference to the following drawings. The components in the drawings are not necessarily to scale, emphasis instead being placed upon clearly illustrating the principles of the present disclosed double cardan joint assembly and method. Moreover, in the drawings, like reference numerals designate corresponding parts throughout the several views.

FIGS. 1A-1B are schematic diagrams that illustrate an example structure and rotational speed performance, respectively, for a conventional single king pin double cardan joint.

FIG. 2A is a schematic diagram that illustrates, in a first isometric view, an embodiment of a double cardan joint assembly.

FIG. 2B is a schematic diagram that illustrates, in an isometric view, an example arrangement of a center frame and axle frames coupled via pins in an embodiment of a double cardan joint assembly.

FIG. 3 is a schematic diagram that illustrates, in a second isometric view, an embodiment of a double cardan joint assembly.

FIG. 4 is a schematic diagram that illustrates, in left elevation view, an embodiment of a double cardan joint assembly.

FIG. 5 is a schematic diagram that illustrates, in right elevation view, an embodiment of a double cardan joint assembly.

FIG. 6 is a schematic diagram that illustrates, in rear elevation view, an embodiment of a double cardan joint assembly.

FIG. 7 is a schematic diagram that illustrates, in close-up view, a universal joint on a driven side of an embodiment of a double cardan joint assembly.

FIG. 8 is a schematic diagram that illustrates, in close-up view, a universal joint on a driving side of an embodiment of a double cardan joint assembly.

FIG. 9 is a schematic diagram that illustrates, in isolated view, a center yoke of an embodiment of a double cardan joint assembly.

FIGS. 10A and 10B are schematic diagrams that illustrate an embodiment of a double cardan joint assembly according to a 90 degree articulation angle and corresponding rotational speed performance.

FIGS. 11A and 11B are schematic diagrams that illustrate an embodiment of a double cardan joint assembly according to a 52 degree articulation angle and corresponding rotational speed performance.

FIGS. 12A and 12B are schematic diagrams that illustrate an embodiment of a double cardan joint assembly according to a 35 degree articulation angle and corresponding rotational speed performance.

FIGS. 13A and 13B are schematic diagrams that illustrate an embodiment of a double cardan joint assembly according to a zero degree articulation angle and corresponding rotational speed performance.

FIGS. 14A and 14B are schematic diagrams that conceptually illustrate the difference in rotational angle through a portion of an articulation range between a center frame and a backside of axle frames of an embodiment of a double cardan joint assembly.

FIG. 15 is a flow diagram that illustrates an embodiment of a double cardan joint method.

### DESCRIPTION OF EXAMPLE EMBODIMENTS

### Overview

In one embodiment, a drive axle, comprising: a first axle frame comprising a first pair of gears at opposing sides of one end of the first axle frame, each of the gears comprising a hole; a second axle frame comprising a second pair of gears at opposing sides of one end of the second axle frame adjacent the one end of the first axle frame, each of the gears comprising a hole, the first pair of gears intermeshing with the second pair of gears throughout an articulation range; a center frame disposed between the first and second axle frames, the first and second axle frames coupled to the center frame by plural pins disposed in the holes of the first and second pairs of gears; a driving shaft surrounded at least in part by the first axle frame and comprising a first yoke; a driven shaft surrounded at least in part by the second axle frame and comprising a second yoke; a double cardan joint, the double cardan joint coupled to the first and second yokes, wherein the center frame surrounds at least a portion of the double cardan joint.

### DETAILED DESCRIPTION

Certain embodiments of a double cardan joint assembly are disclosed that use axle frames to control universal joint angles of the assembly. In one embodiment, the double cardan joint assembly comprises two sets of vertical pins (e.g., four pins total) that are arranged the same distance apart as the universal joints (also, referred to as crosses) in the final assembly. The pins are located on the same vertical plane as the universal joints. The end mounting frames are connected by a center frame, wherein each of the end mounting frames comprises a pair of gears (respective gear sets) that control a relationship between each other and the center frame. In one embodiment, the outer frame angle changes at twice the rate as the center frame angle through a range of articulation angles. One benefit of certain embodiments of a double cardan joint assembly is the ability to maintain equal velocities between the driving and driven shaft, which in turn, reduces the vibration and/or hopping effects experienced with single king pin type joint assemblies, such as for various turning radiuses.

Digressing briefly, conventional double cardan joints comprise a single set of king pins that are disposed between respective end frame holes that overlap, with back-to-back yokes of the double cardan joint disposed between coupled axle frames joined at a single hinge location made possible by the single set of king pins. However, one shortcoming to this arrangement is the inequality of the U-joint angles that couple the back-to-back yokes with yokes of the driving and driven shafts encased by the respective axle frames, which leads to large, sinusoidal speed changes at the driven side (e.g., speeds of the driving and driven side are unequal except at zero degrees). In certain embodiments of a double cardan joint assembly, the control of the outer frame angle relative to the center frame angle enables, for instance, a powered wheel steering system that can mechanically bend at twice the allowable bend of a conventional universal joint. One benefit to certain embodiments of a double cardan joint assembly is in the automobile industry, where all four wheels of a 4-wheel drive vehicle may be turned 90 degrees (or more) to enable the vehicle to park directly from the side of the parking space.

Having summarized certain features of a double cardan joint assembly of the present disclosure, reference will now be made in detail to the description of a double cardan joint assembly as illustrated in the drawings. While an example double cardan joint assembly will be described in connection with these drawings, there is no intent to limit it to the embodiment or embodiments disclosed herein. For instance, though emphasis is placed on drive axles (front or rear drive axles), certain embodiments of a double cardan joint assembly may be beneficially deployed in other applications that transfer rotational speed of a driving shaft to a driven shaft, such as drivelines or other drive shafts. Further, many applications from a wide range of industries are contemplated to benefit from, and be within the scope of, certain embodiments of a double cardan joint assembly, including from the consumer automobile industry to the work vehicle industry. For instance, an embodiment of a double cardan joint assembly may be used on a wheel tractor with a loader to steer within its footprint much like a skid steer with a load on the loader without skidding anything. One of the rear wheels may actually turn backwards if the steering system exceeded 90 degrees. Further, although the description identifies or describes specifics of one or more embodiments, such specifics are not necessarily part of every embodiment, nor are all of any various stated advantages necessarily associated with a single embodiment. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

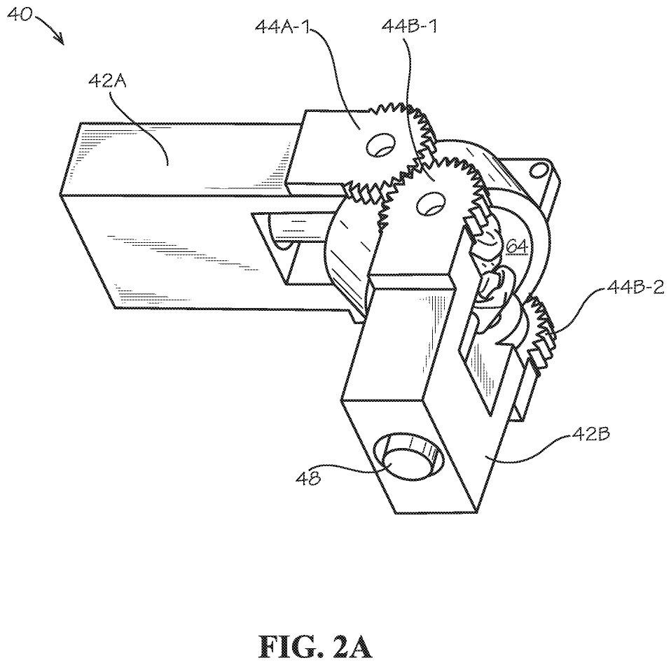

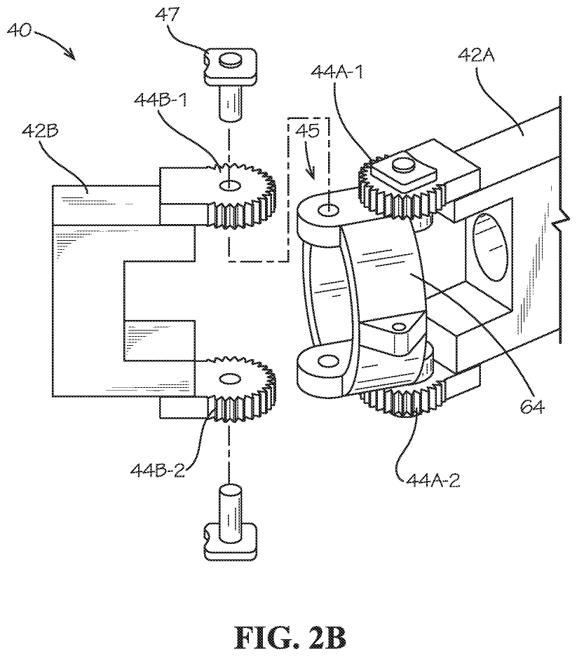

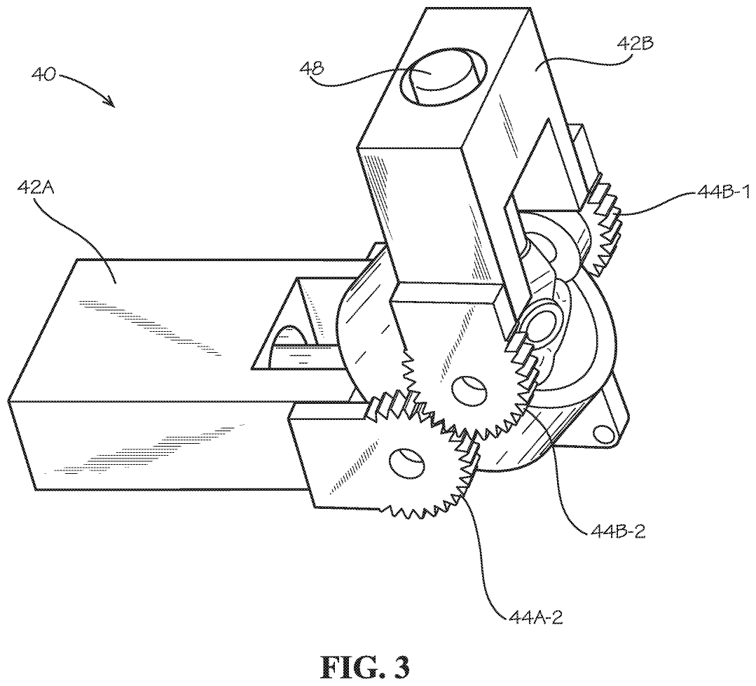

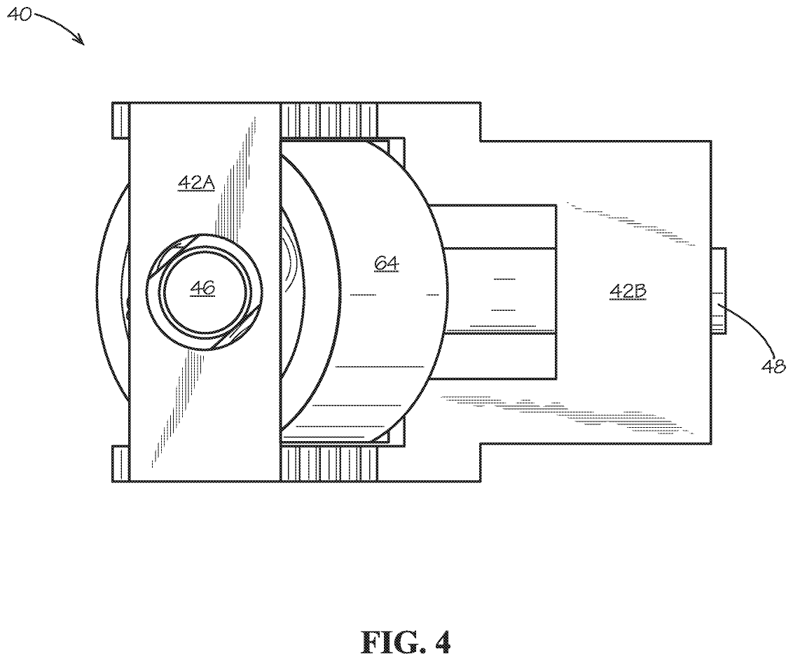

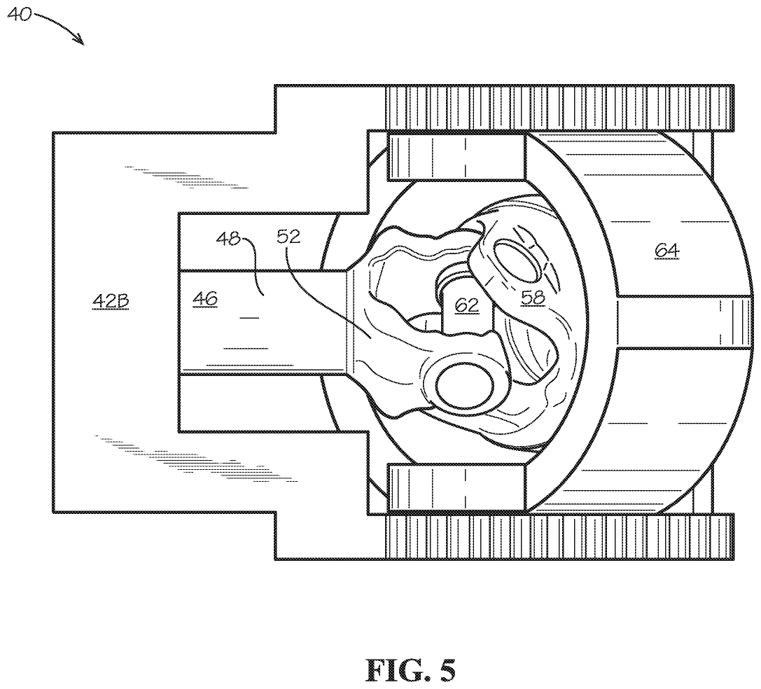

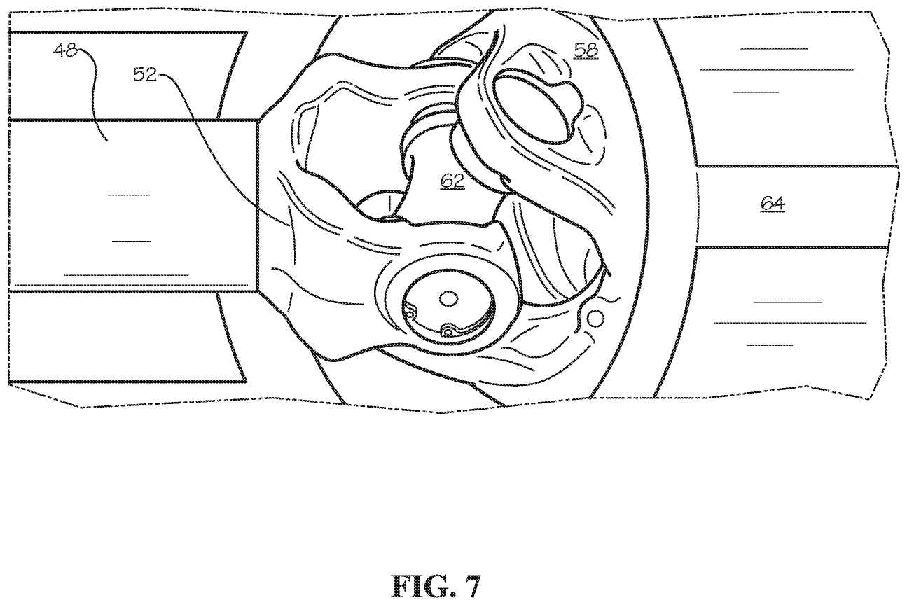

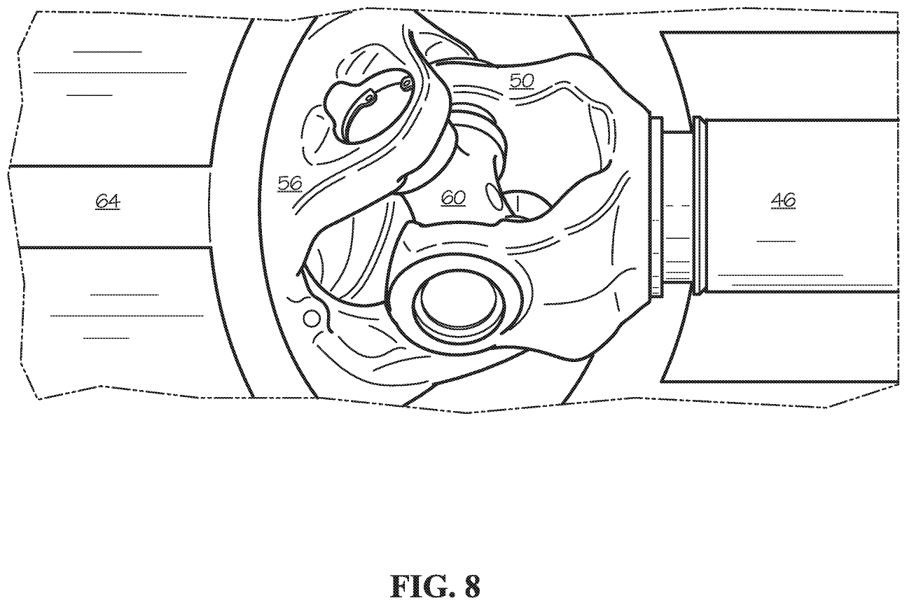

Referring now to FIGS. 2A-9, shown are various views of an embodiment of a double cardan joint assembly 40 (note that the pins are omitted in all of the figures except FIG. 2B, which omits the shafts, for illustrative clarity). The double cardan joint assembly 40 is described in the context of a drive axle (and in particular, a steering system axle), though it should be appreciated by one having ordinary skill in the art in the context of the present disclosure that the double cardan joint assembly may be used in drivelines or other drive shafts, and hence drive axles, drive shaft, and drivelines are contemplated to be within the scope of the disclosure. The double cardan joint assembly 40 comprises axle frames 42A, 42B. A first end of the axle frame 42A comprises a pair of gears 44A (e.g., 44A-1 and 44A-2). The gears 44A may be integrated into the frame 42A (e.g., cast, welded). A first end of the axle frame 42B (adjacent the first end of the axle frame 42A) comprises a pair of gears 44B (e.g., 44B-1, 44B-2). The gears 44B may be integrated into the frame 42B (e.g., cast, welded). The gears 44A and 44B intermesh throughout an articulation range of the frames 42A, 42B. In one embodiment, the articulation range may be from zero degrees to 90 degrees, or more. In general, the articulation range is limited by the bend limit of the U-joint. The gears 44A (44A-1, 44A-2) comprise centrally disposed and aligned holes (one on each external side) through which pins 47 (shown only in FIG. 2B) are disposed. Similarly, the gears 44B (44B-1, 44B-2) comprise centrally disposed and aligned holes (one on each external side) through which pins 47 are disposed. The gears 44A, 44B control a relationship between each other and a center frame (described below) via the pin connections. The axle frame 42A surrounds, at least in part, a driving shaft 46. In other words, except for one or both ends of the driving shaft 46, the driving shaft 46 is surrounded by all (e.g., four) sides of the axle frame 42A. In some embodiments, all or a portion of the entire length of the driving shaft 46 may be visible from at least one side of the axle frame 42A (e.g., the axle frame 42A may consist of less than four sides in some embodiments). One end of the driving shaft 46 may be operably coupled to a driveline (not shown), such as via a universal joint, CV joint, double cardan joint, or an embodiment of a double cardan joint assembly 40. The axle frame 42B surrounds, at least in part, a driven shaft 48. In other words, except for one or both ends of the driven shaft 48, the driven shaft 48 is surrounded by all (e.g., four) sides of the axle frame 42B. In some embodiments, all or a portion of the entire length of the driven shaft 48 may be visible from at least one side of the axle frame 42B (e.g., the axle frame 42B may consist of less than four sides in some embodiments). One end of the driven shaft 48 may be operably coupled to a wheel (e.g., wheel hub) (not shown), such as via a universal joint, CV joint, double cardan joint, or an embodiment of a double cardan joint assembly 40.

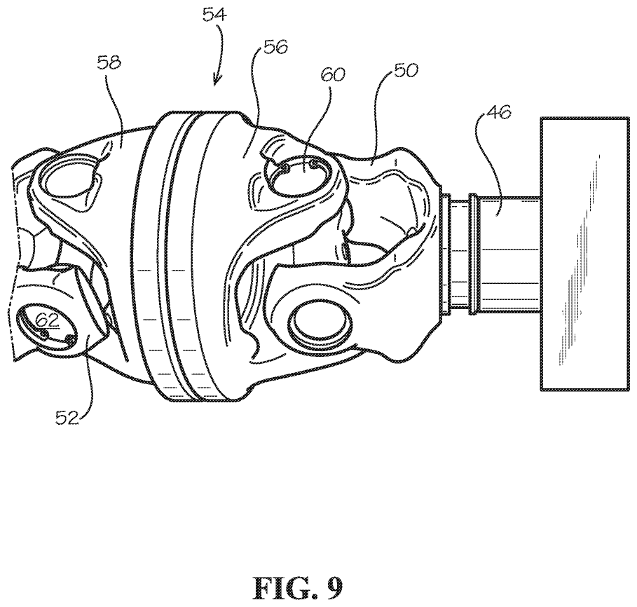

At the first end of the driving shaft 46 is a yoke 50. The yoke 50 may be cast or welded to the driving shaft 46. At the first end of the driven shaft 48 is a yoke 52, which likewise may be a cast or welded component. The opposite end of respective shafts 46, 48 may likewise comprise respective yokes in some embodiments. The yokes 50, 52 are coupled to a center yoke 54 (best seen fully in FIG. 9). The center yoke 54 comprises a double cardan joint, including two back-to-back yokes 56 and 58. The yoke 50 is coupled to the yoke 56 via a universal joint (or cross) 60. The yoke 52 is coupled to the yoke 58 via a universal joint (or cross) 62.

Surrounding all, or in part, the center yoke 54 is a center frame 64 (omitted in FIG. 9 to better illustrate the center yoke 54). The center frame 64 is disposed between the first and second axle frames 42A, 42B. As best shown in FIG. 2B, in one embodiment, the center frame 64 comprises a ring-like structure with fore and aft projections on opposing ends (top and bottom) that each comprise a hole 45. For instance, in the depicted embodiment of FIG. 2B (shown with the shafts omitted), the center frame 64 comprises a respective pair of holes 45 on the top and bottom sides of the center frame 64, with each hole in a projection of the ring-like structure disposed on each side of the ring. The center frame 64 is coupled to the axle frame 42A, 42B via double king pins, for instance pins 47 (only shown in FIG. 2B). For instance, the axle frame 42A is coupled to the center frame 64 via two pins 47 (one pair) disposed through holes in the gears 44A-1 and 44A-2 and through the respective top and bottom holes 45 of projections on one side of the ring of the center frame 64. Similarly, the axle frame 42B is coupled to the center frame 64 via two pins 47 (another pair) disposed through holes in the gears 44B-1 and 44B-2 and through the respective top and bottom holes 45 of projections on the other side of the ring of the center frame 64 (shown in projection, particularly via dashed line for the top end). Thus, the two sets or pairs of vertical pins (e.g., four pins total) through the holes of the gears 44A, 44B and the holes 45 of the center frame 64 are arranged the same distance apart as the universal joints 60, 62. The pins are located on the same vertical plane as the universal joints 60, 62. Note that the triangular projection (with the hole) from the center frame 64 in FIG. 2B may provide a location for attachment to a steering mechanism.

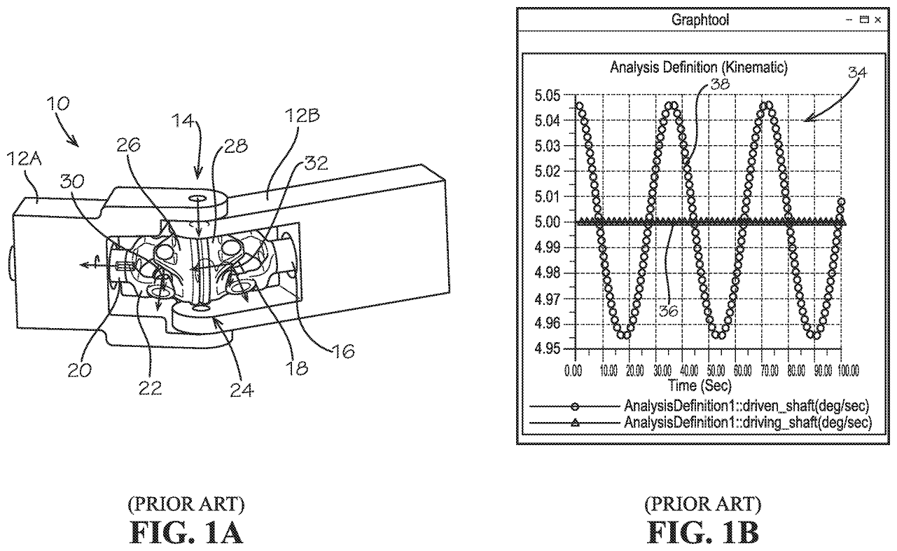

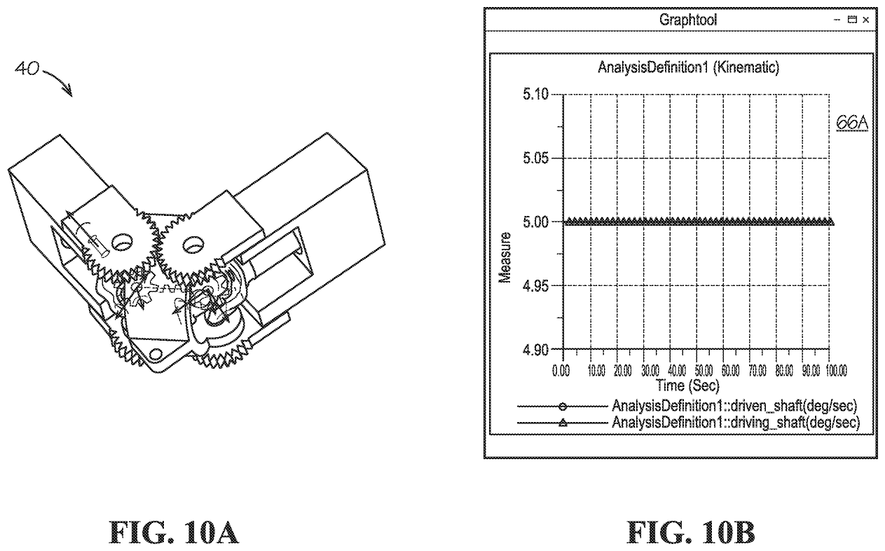

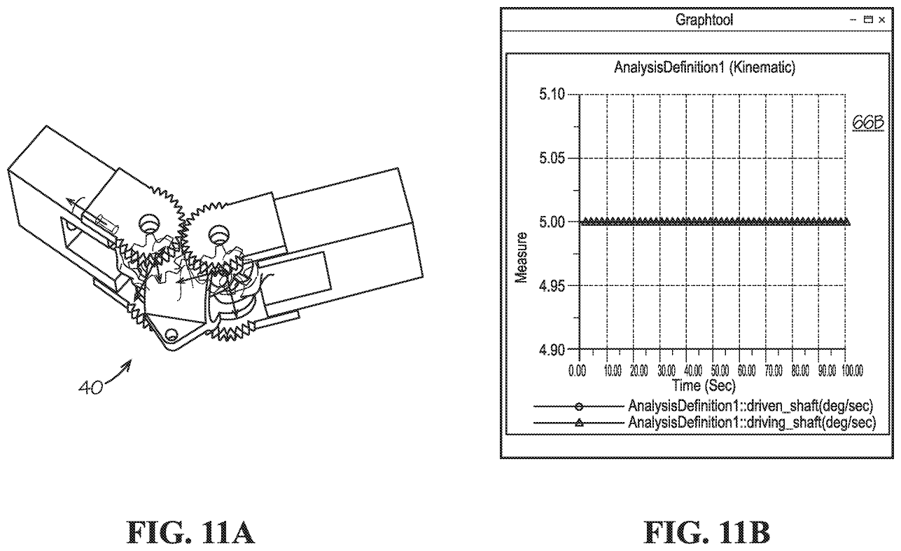

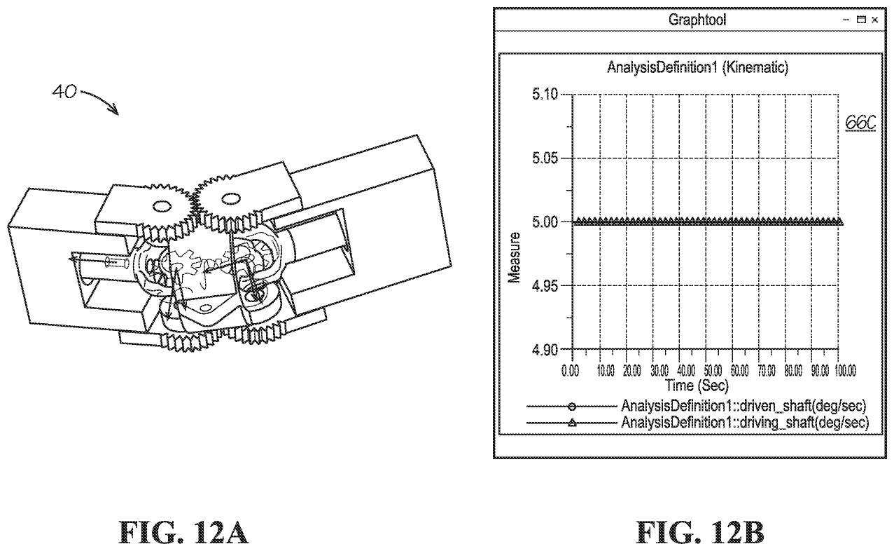

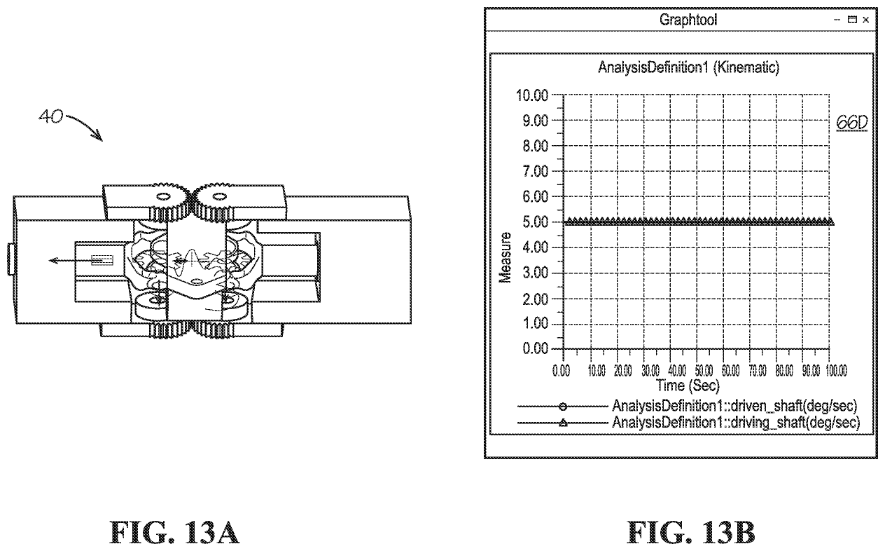

Referring now to FIGS. 10A-13B, shown are schematic diagrams that illustrate an embodiment of a double cardan joint assembly according to various angles of articulation angle and the corresponding rotational speed performance. The example double cardan joint assembly depicted in FIGS. 10A, 11A, 12A, and 13A may be embodied as the double cardan joint assembly 40 illustrated in FIGS. 2A-9 (yet with the pins omitted for simplicity in illustration). Referring to FIGS. 10A-10B, shown (in FIG. 10A) is the double cardan joint assembly 40 (in isometric view) according to an articulation angle of 90 degrees. In FIG. 10B, shown is a screen shot of a chart diagram 66A depicting a measurement of velocity or rotational speed (Y-axis in degrees/second (deg/sec)) versus time (X-axis, in seconds) for the driving shaft 46 and the driven shaft 48 (FIGS. 2-9) for the articulation angle of 90 degrees. As depicted in FIG. 10B, the rotational speeds for the driving and driven shafts 46, 48 are equal (the lines overlap). Referring to FIGS. 11A-11B, the double cardan joint assembly 40 comprises an articulation angle of 52 degrees, and the chart diagram 66B reveals equal rotational speeds (overlap in lines) between the driving and driven shafts 46, 48. Referring to FIGS. 12A-12B, the double cardan joint assembly 40 comprises an articulation angle of 35 degrees, and the chart diagram 66C reveals equal rotational speeds (overlap in lines) between the driving and driven shafts 46, 48. Note the difference between the chart diagram 66C and the chart diagram 34 for a conventional double cardan joint as illustrated in FIG. 1B, the latter revealing unequal driving and driven rotational speeds. Referring to FIGS. 13A-13B the double cardan joint assembly 40 comprises an articulation angle of zero degrees, and the chart diagram 66D reveals equal rotational speeds (overlap in lines) between the driving and driven shafts 46, 48. As indicated above, one benefit to the equal velocities is reduced wheel hop and/or shudder.

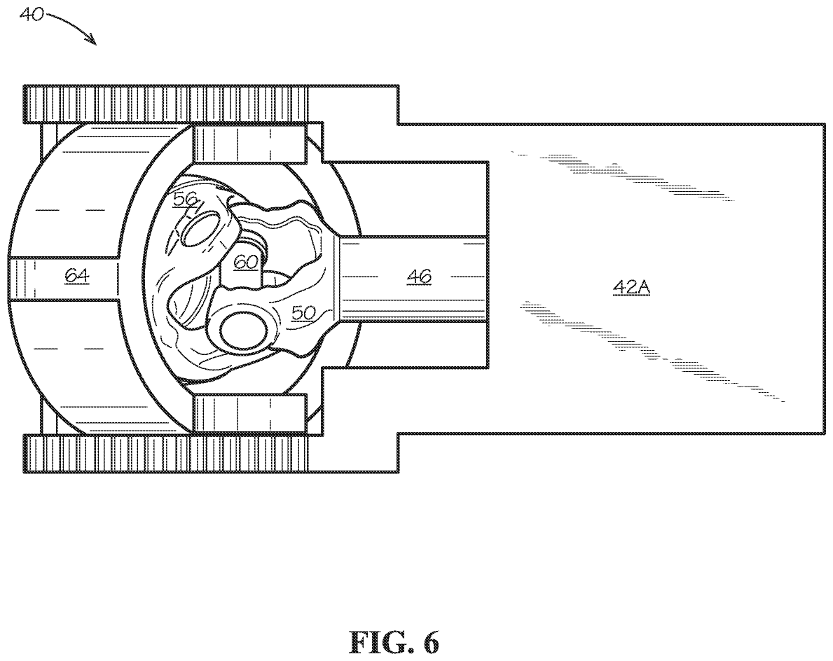

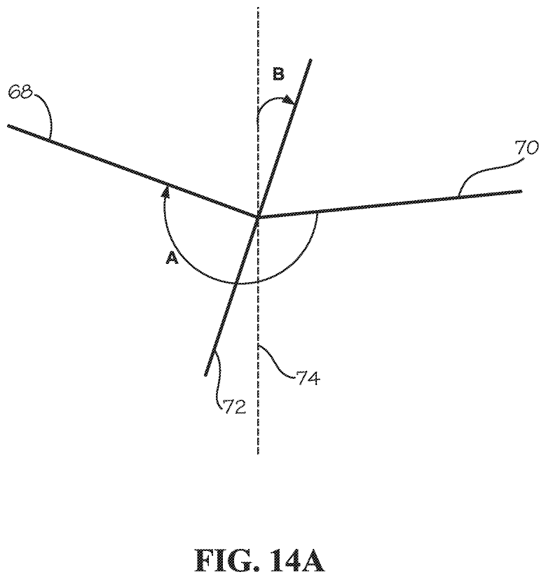

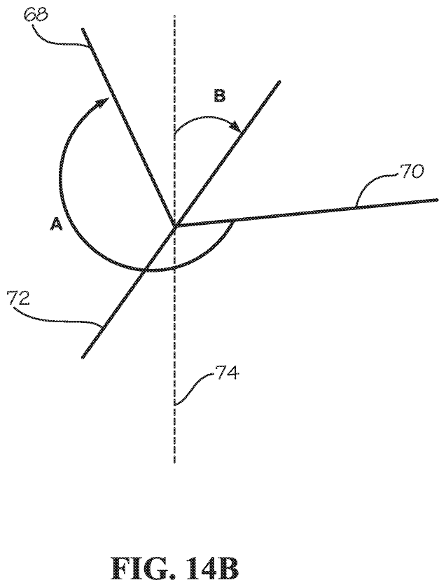

Attention is now directed to FIGS. 14A and 14B, which conceptually illustrate the difference in rotational angle through a portion of an articulation range between the center frame 64 (e.g., FIG. 6) and a backside of the axle frames (e.g., FIG. 2, frames 42A, 42B) for an embodiment of a double cardan joint assembly. Lines 68, 70 represent the axle frames 42A, 42B, and Angle A represents the backside angle formed between the lines 68, 70 (and hence axle frames 42A, 42B). Line 72 represents the axis of rotation of the center frame 64, with dashed line 74 representing a datum or reference for the dashed line 74 (and hence for the center frame 64), with the angle of articulation for the line 72 (and hence center frame 64) represented by angle, B. In FIG. 14A, the lines 68 and 70 correspond similarly to an angle of articulation as shown in FIG. 12A (e.g., approximately 35 degrees). Note that the backside angle of the frames (e.g., angle A formed between lines 68 and 70) is as shown, whereas the angle B of the center frame is smaller (smaller than angle A). In FIG. 14B, the lines 68 and 70 form an articulation angle similar to that shown in FIG. 10A (approximately 90 degrees). The backside angle A has increased substantially more than the center frame angle, B. In other words, the change in angle B is less than the change in angle, A throughout the articulation range. In one embodiment, the outer frame angle, A, changes at twice the rate as the center frame angle, B.

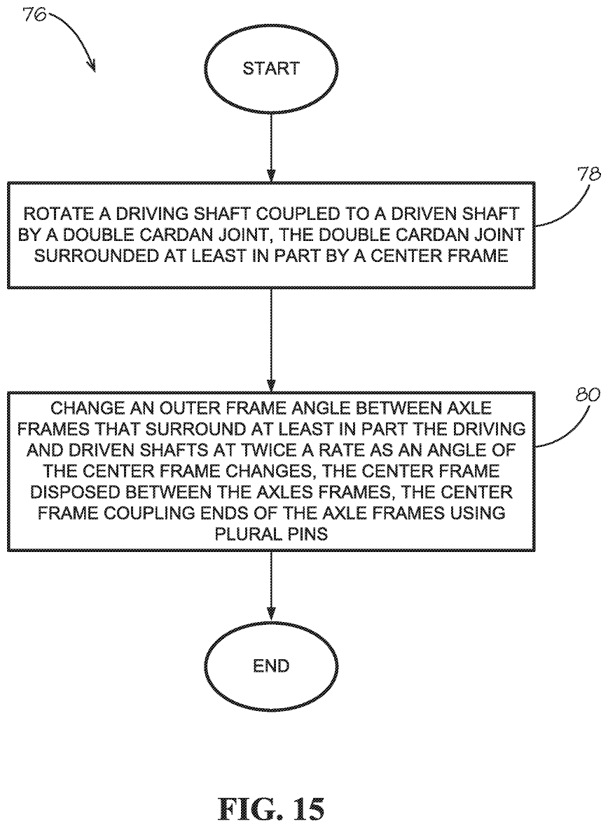

In view of the above description, it should be appreciated that one embodiment of double cardan joint method, depicted in FIG. 15 and denoted as method 76, comprises rotating a driving shaft coupled to a driven shaft by a double cardan joint, the double cardan joint surrounded at least in part by a center frame (78); and changing an outer frame angle between axle frames that surround at least in part the driving and driven shafts at twice a rate as an angle of the center frame changes, the center frame disposed between the axles frames, the center frame coupling ends of the axle frames using plural pins (80).

Any process descriptions or blocks in flow diagrams should be understood as representing steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein. Although an embodiment of a double cardan joint assembly and method have been described with reference to the example embodiments illustrated in the attached drawing figures, it is noted that equivalents may be employed and substitutions made herein without departing from the scope of the disclosure as protected by the following claims.

1. A drive axle, comprising:
a first axle frame comprising a first pair of gears at opposing sides of one end of the first axle frame, each of the gears comprising a hole;
a second axle frame comprising a second pair of gears at opposing sides of one end of the second axle frame adjacent the one end of the first axle frame, each of the gears comprising a hole, the first pair of gears intermeshing with the second pair of gears throughout an articulation range;
a center frame disposed between the first and second axle frames, the first and second axle frames coupled to the center frame by plural pins disposed in the holes of the first and second pairs of gears;
a driving shaft surrounded at least in part by the first axle frame and comprising a first yoke;
a driven shaft surrounded at least in part by the second axle frame and comprising a second yoke; and
a double cardan joint, the double cardan joint coupled to the first and second yokes, wherein the center frame surrounds at least a portion of the double cardan joint.

2. The drive axle of claim 1, wherein plural pins comprises four pins.

3. The drive axle of claim 1, wherein the double cardan joint comprises a center yoke comprising back-to-back yokes, the back-to-back yokes comprising a third yoke and a fourth yoke.

4. The drive axle of claim 3, wherein the double cardan joint comprises first and second universal joints, wherein the third yoke is coupled to the first yoke via the first universal joint, wherein the fourth yoke is coupled to the second yoke via the second universal joint.

5. The drive axle of claim 4, wherein a distance between the holes of the first pair of gears and the holes of the second pair of gears is the same as a distance between the first and second universal joints.

6. The drive axle of claim 1, wherein the driving shaft and driven shaft are rotatable within the first and second axle frames, respectively.

7. The drive axle of claim 6, wherein a rotational speed of the driven shaft equals a rotational speed of the driving shaft throughout the articulation range.

8. The drive axle of claim 1, wherein throughout the articulation range, an outer angle between the first and second axle frames changes at twice a rate as an angle of the center frame changes.

9. The drive axle of claim 1, wherein the center frame comprises a ring-like structure having a pair of holes on opposing ends of the ring-like structure with each hole of the pair on each side of the ring-like structure, the holes for receiving the plural pins.

10. A method, comprising:
rotating a driving shaft coupled to a driven shaft by a double cardan joint, the double cardan joint surrounded at least in part by a center frame; and
changing an outer frame angle between axle frames that surround at least in part the driving and driven shafts at twice a rate as an angle of the center frame changes, the center frame disposed between the axle frames, the center frame coupling ends of the axle frames using plural pins.

11. The method of claim 10, wherein the axle frames comprise a first axle frame and a second axle frame, the first axle frame comprising a first pair of gears at opposing sides of one end of the first axle frame, each of the gears comprising a hole, the second axle frame comprising a second pair of gears at opposing sides of one end of the second axle frame adjacent the one end of the first axle frame, each of the gears of the second pair comprising a hole, wherein changing the outer frame angle comprises the intermeshing the first pair of gears with the second pair of gears throughout an articulation range.

12. The method of claim 10, wherein a rotational speed of the driven shaft equals a rotational speed of the driving shaft throughout an articulation range.

13. The method of claim 10, wherein the center frame comprises a ring-like structure having a pair of holes on opposing ends of the ring-like structure with each hole of the pair on each side of the ring-like structure, the holes for receiving the plural pins.

14. A system, comprising:
a first axle frame comprising a first pair of gears at opposing sides of one end of the first axle frame, each of the gears comprising a hole;
a second axle frame comprising a second pair of gears at opposing sides of one end of the second axle frame adjacent the one end of the first axle frame, each of the gears comprising a hole, the first pair of gears intermeshing with the second pair of gears throughout an articulation range;
a center frame disposed between the first and second axle frames, the first and second axle frames coupled to the center frame by plural pins disposed in the holes of the first and second pairs of gears;
a driving shaft surrounded at least in part by the first axle frame and comprising a first yoke;
a driven shaft surrounded at least in part by the second axle frame and comprising a second yoke;
a center yoke comprising back-to-back yokes, the back-to-back yokes comprising a third yoke and a fourth yoke; and
first and second universal joints, wherein the third yoke is coupled to the first yoke via the first universal joint, wherein the fourth yoke is coupled to the second yoke via the second universal joint.

15. The system of claim 14, wherein plural pins comprises four pins.

16. The system of claim 14, wherein a distance between the holes of the first pair of gears and the holes of the second pair of gears is the same as a distance between the first and second universal joints.

17. The system of claim 14, wherein the driving shaft and driven shaft are rotatable within the first and second axle frames, respectively.

18. The system of claim 17, wherein a rotational speed of the driven shaft equals a rotational speed of the driving shaft throughout the articulation range.

19. The system of claim 14, wherein throughout the articulation range, an outer angle between the first and second axle frames changes at twice a rate as an angle of the center frame changes.

20. The system of claim 14, wherein the center frame comprises a ring-like structure having a pair of holes on opposing ends of the ring-like structure with each hole of the pair on each side of the ring-like structure, the holes for receiving the plural pins.
